(19) United States
(12) Patent Application Publication
(10) Pub. No.: US 2013/0304867 A1
(43) Pub. Date: Nov. 14, 2013

(54) METHODS AND SYSTEMS TO EFFICIENTLY RETRIEVE A DATA ELEMENT

(71) Applicant: Srinivasan Raman, Cupertino, CA (US)

(72) Inventor: Srinivasan Raman, Cupertino, CA (US)

(73) Assignee: eBay Inc., San Jose, CA (US)

(21) Appl. No.: 13/471,591

(22) Filed: May 15, 2012

Related U.S. Application Data
(60) Provisional application No. 61/645,419, filed on May 10, 2012.

(51) Int. Cl. G06F 15/16

(52) U.S. Cl. 709/219

(57) ABSTRACT

Methods and systems to efficiently retrieve a data element are described. The system may receive a first request over a connection from a first network device. The first request is associated with a first domain. The first request is received at a load balancer server and further identifies a first plurality of records that are included in a data element. Next, the system routes the first request to a first application server. Finally, the system receives a first response from the first application server. The first response includes a request identifier and an indication to remember the first application server.

### RELATED APPLICATIONS

This application claims the priority benefit of U.S. Provisional Application No. 61/645,419, filed May 10, 2012 which is incorporated herein by reference.

### TECHNICAL FIELD

This disclosure relates to methods and systems supporting data communication systems. More particularly, methods and systems to efficiently retrieve a data element are described.

### RELATED ART

A user may operate a client machine to retrieve a portion of a data element from a remote network device. In some instances, the user may successively select multiple portions of the same data element causing the data element to be retrieved multiple times from persistent storage.

### BRIEF DESCRIPTION OF THE DRAWINGS

Embodiments are illustrated by way of example and not limitation in the figures of the accompanying drawings, in which:

FIG. 1 illustrates a system to efficiently retrieve a data element, according to an embodiment;

FIG. 2 illustrates a data center system, according to an embodiment;

FIG. 3A illustrates a load balancer server, according to an embodiment;

FIG. 3B illustrates an application server, according to an embodiment;

FIG. 4A illustrates load balancer persistence information, according to an embodiment;

FIG. 4B illustrates load balancer keep-alive information, according to an embodiment;

FIG. 5A illustrates load balancer configuration information, according to an embodiment;

FIG. 5B illustrates application server request information, according to an embodiment;

FIG. 5C illustrates an application server cache, according to an embodiment;

FIG. 6A illustrates a request, according to an embodiment;

FIG. 6B illustrates a response, according to an embodiment;

FIG. 7 illustrates a flow chart of a method to efficiently retrieve a data element, according to an embodiment;

FIG. 8 illustrates a flow chart of a method to route a request, according to an embodiment;

FIG. 9 illustrates a flow chart of a method to process a response at a load balancer, according to an embodiment;

FIG. 10 illustrates a flow chart of a method to process a web load balancer tier, according to an embodiment;

FIG. 11A illustrates a flow chart of a method to service a timeout for a persisted connection, according to an embodiment; and

FIG. 11B illustrates a flow chart of a method to service a timeout for a kept-alive connection, according to an embodiment; and

FIG. 12 shows a diagrammatic representation of a machine in the form of a computer system within which a set of instructions, for causing the machine to perform any one or more of the methodologies discussed herein, may be executed, according to an example embodiment.

### DETAILED DESCRIPTION

In the following description, for purposes of explanation, numerous specific details are set forth in order to provide a thorough understanding of some example embodiments. It will be evident, however, to one of ordinary skill in the art that embodiments of the present disclosure may be practiced without these specific details.

As described further below, according to various example embodiments of the disclosed subject matter described and claimed herein, methods and systems to efficiently retrieve a data element are provided. Various embodiments are described below in connection with the figures provided herein.

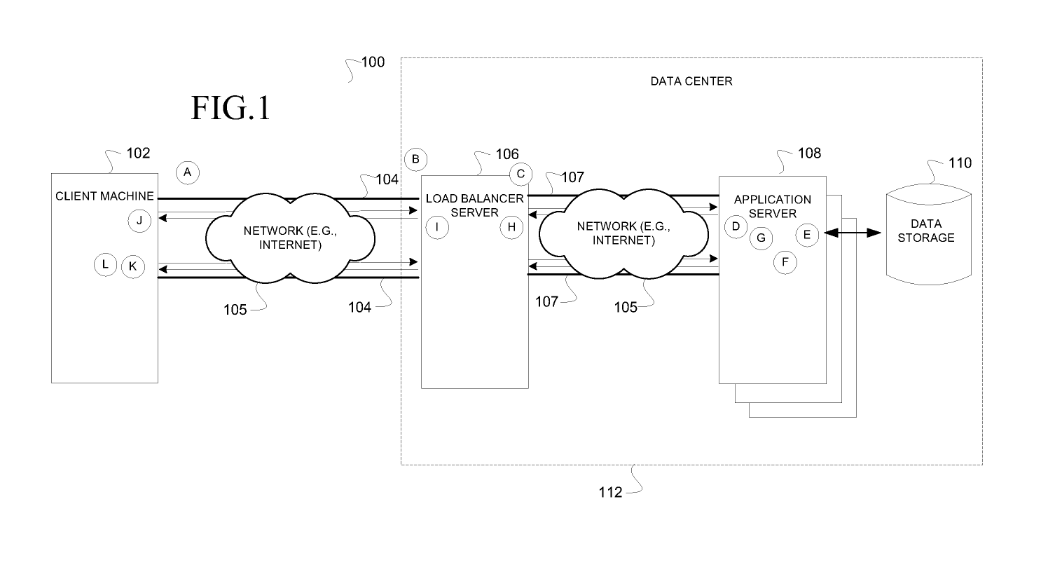

FIG. 1 illustrates a system 100 to efficiently retrieve a data element, according to an embodiment. Broadly, at operation A, a client machine 102 may receive a selection that identifies a portion of a data element, establish a connection 104 over a network 105 with a load balancer server 106, and communicate a request for the portion of the data element to the load balancer server 106. For example, the client machine may receive a first selection from a user that identifies the first twenty data records (e.g., data records 0-19) of a data element (e.g., file) that includes three-thousand data records and communicate the request to the load balancer server 106. At operation B, the load balancer server 106 may receive the request and, at operation C, route the request to an application server 108. For example, routing the request may include selecting one of multiple application servers 108 that are capable of processing the request, establishing a connection 107 with the selected application server 108, and communicating the request over the connection 107 to the application server 108. At operation D, the application server 108 may receive the request and, at operation E, retrieve the entire file including all three-thousand data records from data storage 110. At operation F, the application server 108 may store the file in a cache that is local to the application server 108. At operation G, the application server 108 may generate a response that includes the first twenty data records, an asserted remember-me flag indicating the application server 108 is to be remembered for an associated period of time with an associated timeout, and an asserted keep-alive flag indicating the connection 104 is to be kept-alive with a separate associated timeout. Other embodiments may include a flag and timeout for none or only one of the connections 104 or 107. In some embodiments the remember-me flag may also be utilized to persist the connection 104. Further, at operation G, the application server 108 may communicate the response over the connection 107 to the load balancer server 106. At operation H, the load balancer server 106 may receive the response over the connection 107 and at operation I, the load balancer server 106 may communicate the response over the connection 104 to the client machine 102. The load balancer server 106 may respond to the asserted remember-me flag in the response by adding an entry to an internal table, mapping a request identifier present in the response to the selected application server 108, storing a destination identifier that identifies the selected application server 108 in the new entry in the internal table and storing the associated timeout present in the response in the new entry in the internal table. The load balancer server 106 may further respond to the asserted keep-alive flag in the response by not disconnecting the connection 104 and setting a timeout for this connection. In one embodiment the application server 108 may respond to the asserted remember-me flag by not disconnecting the connection 104. Further, the load balancer server 106 may override any local configuration information that disables keep-alive for the connection 104. At operation J, the client machine 102 may receive the response and not disconnect the connection 104.

At operation K, the client machine 102 may receive a second selection from the user for the next twenty data records (e.g., data records 20-39) of the same file, thereby repeating the above described steps resulting in the identified data records being retrieved from the cache at the application server 108 and communicated in a response over the connections 104 and 107 to the client machine 102. The above steps may be iterated until the last requested record is selected, thereby causing the above mentioned flags to not be asserted and causing the connections 104 and 107 to be respectively disconnected by the load balancer server 106. Accordingly, the data element may be efficiently retrieved from the application server 108 by retrieving the data element from the cache at the application server 108 rather than persistent storage and by controlling the connections 107 and 104 until the last record is retrieved or the above mentioned timeouts expire. In some embodiments one or more of the connections 107 and 104 may not be controlled.

According to one embodiment, the load balancer server 106, the application server 108, and the data storage 110 may be included in a data center 112. According to another embodiment, the operations described above as being performed within the data center 112 are performed within a cloud. For example, the cloud may include a distributed enterprise network that delivers global enterprise-class network capabilities including the capability described above.

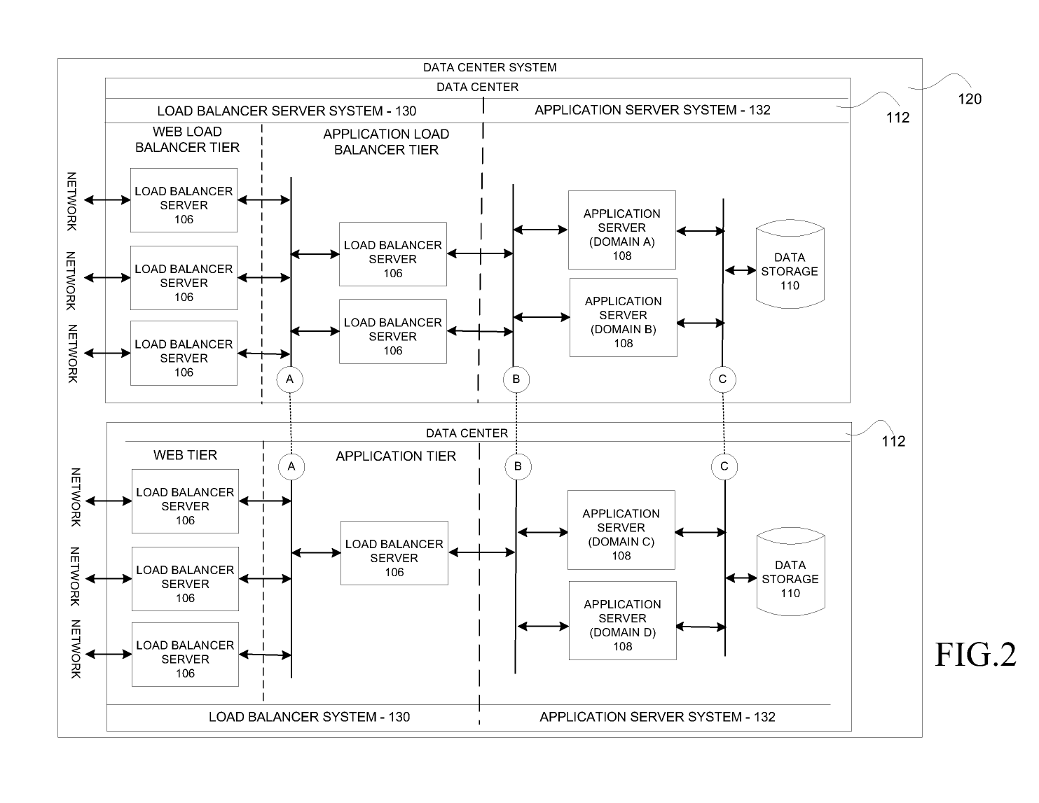

FIG. 2 illustrates a data center system 120, according to an embodiment. The data center system 120 may include one or more data centers 112 that may be connected over communication links A, B, or C, as illustrated. The communication links may be embodied as wireless networks, local area networks (LAN), wide area networks (WAN), or any other medium or technology that supports data communication services. In general, well-known instruction instances, protocols, structures and techniques have not been shown in detail. The data centers 112 shown in FIG. 2 respectively correspond to the data center 112 that is illustrated in FIG. 1. Accordingly, the same or similar references have been used to indicate the same or similar features unless otherwise indicated. Each data center 112 may include a load balancer system 130 and an application server system 132. The load balancer system 130 may include a web load balancer tier including one or more load balancer servers 106 and an application load balancer tier may include one or more load balancer servers 106, as previously described. The load balancer servers 106 in the web load balancer tier may be connected over a network (e.g., the Internet) to client machines 102, not shown. The load balancer servers 106 in the application load balancer tier may be connected to an application server 108 on one side and a load balancer server 106 on the other side, as shown. In another embodiment, a connection may pass through multiple load balancer servers 106 in the application load balancer tier before passing to an application server 108.

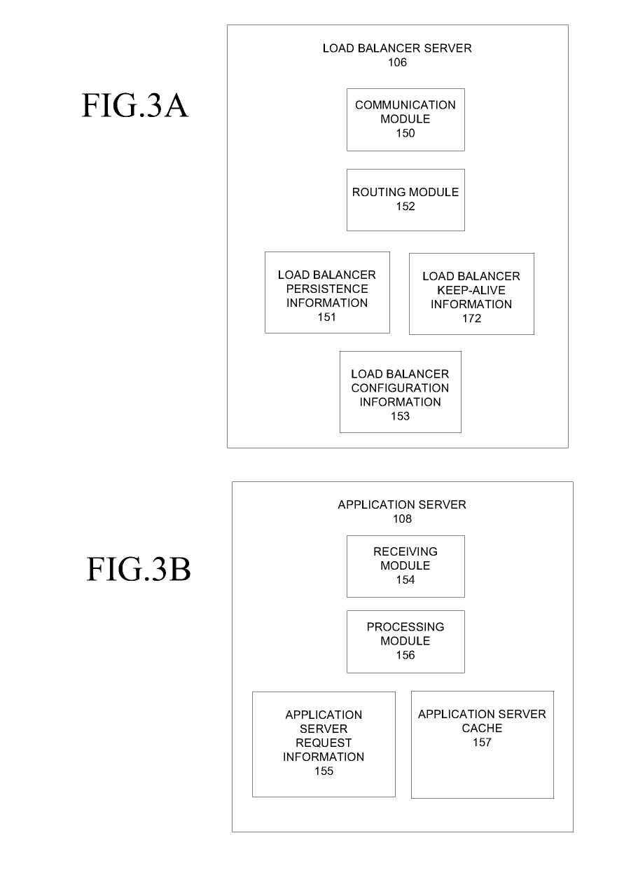

FIG. 3A illustrates a load balancer server 106, according to an embodiment. The load balancer server 106 may include a communication module 150, a routing module 152, load balancer persistence information 151, load balancer keep-alive information 172 and load balancer configuration information 153. The communication module 150 may receive a request from a client machine 102 or a load balancer server 106 and request the routing module 152 to route the request to a second load balancer server 106 or application server 108. The communication module 150 may further receive a response from the second load balancer server 106 or the application server 108 and communicate the response to the client machine 102 or another load balancer server 106. The routing module 152 may route the request to the proper destination. For example, the routing module 152 may route the request to a load balancer server 106 or an application server 108. The routing module 152 may route the request based on a domain that is associated with the request to an application server 108 or a load balancer server 106 that services the domain. The load balancer persistence information 151 may be utilized by the load balancer server 106 to route multiple requests associated with the same data element based on a request identifier present in the uniform resource identifier present in the request. The load balancer configuration information 153 may be configured by an administrator to control a “keep-alive” feature for connections between the load balancer server 106 and client machines 102. Enabling “keep-alive” may allow the connection 104 to remain established to enable subsequent request/response communications over the same connection and disabling “keep-alive” may block this feature resulting in the connection 104 being disconnected. The load balancer server 106 may override the keep-alive feature based on the above described keep-alive flag being asserted in a response. For example, a keep-alive feature that is configured as disabled may be overridden by a keep-alive flag that is asserted in the response thereby causing the connection between the load balancer server 106 and the client machine 102 to be kept alive notwithstanding the “keep-alive” feature.

FIG. 3B illustrates an application server 108, according to an embodiment. The application server 108 may include a receiving module 154, a processing module 156, application server request information 155, and an application server cache 157. The receiving module 154 may receive a request for a data element from a load balancer server 106. The processing module 156 may retrieve a portion of the data element from the application server cache 157, retrieve the entire data element from the data storage 110 (not shown), generate a response including a portion of the data element, and communicate the response to the load balancer server 106. The processing module 156 may further communicate a response that includes header information that includes a request identifier, a remember-me flag, persistence timeout information, a keep-alive flag and keep-alive timeout information. The application server request information 155 may be utilized by the application server 108 to manage requests and responses. The application server cache 157 may be utilized by the application server 108 to store data elements and to retrieve portions of the data elements.

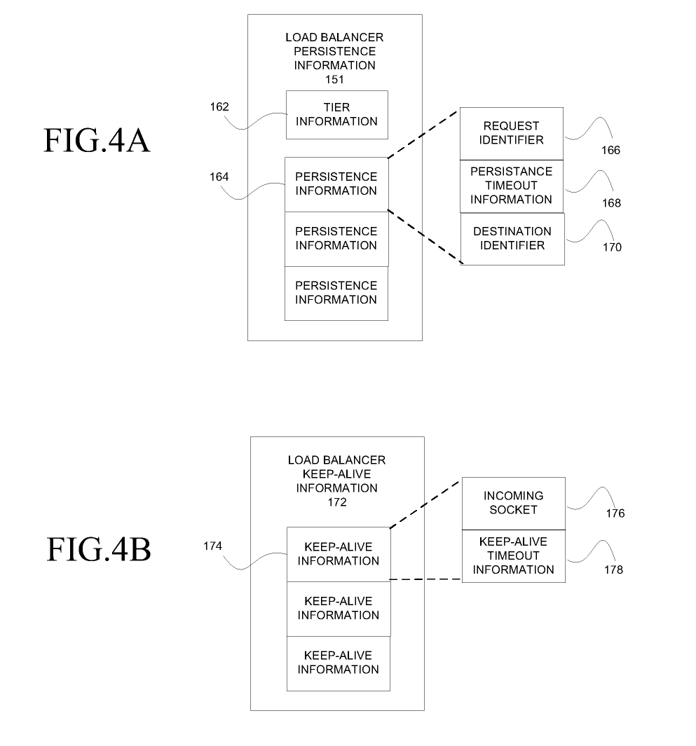

FIG. 4A illustrates load balancer persistence information 151, according to an embodiment. The load balancer persistence information 151 may be stored on the load balancer server 106 and utilized by the load balancer server 106 to manage requests and responses. The load balancer persistence information 151 may include tier information 162 and persistence information 164.

The tier information 162 may indicate the relative location of the load balancer server 106 in a data center system 120, as shown in FIG. 2. For example, the tier information 162 may indicate whether the load balancer server 106 is located in a web load balancer tier or an application load balancer tier.

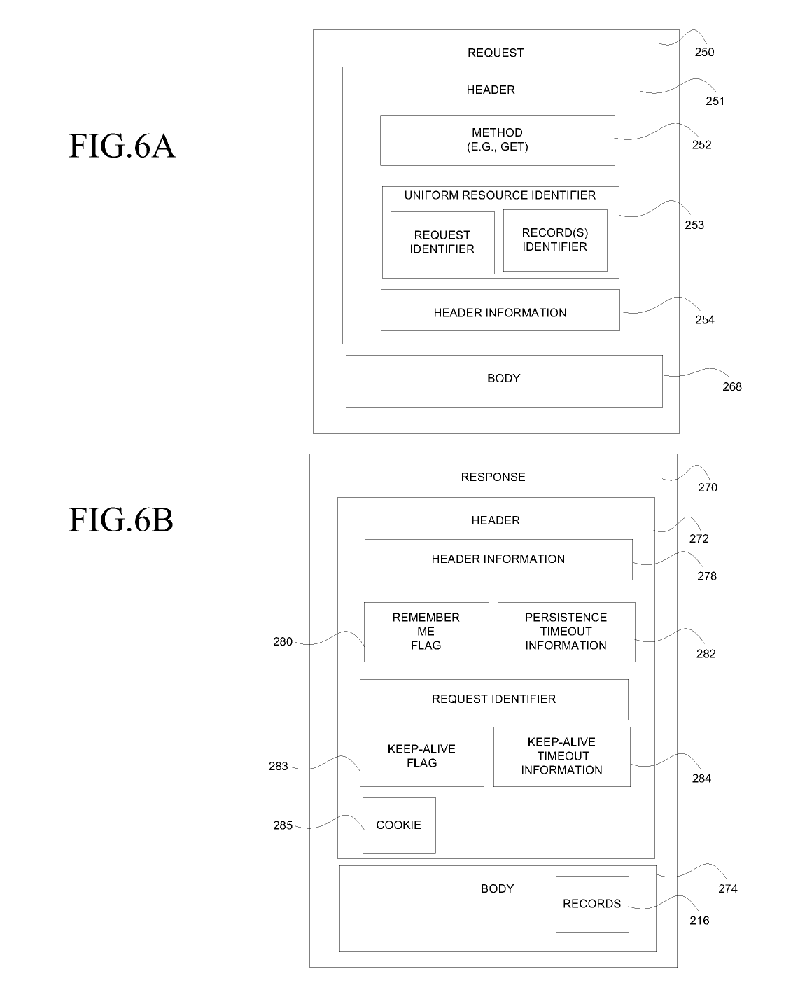

The persistence information 164 may be stored by the load balancer server 106 responsive to receiving a response that is not already registered in the load balancer persistence information 151. Each persistence information 164 entry may include a request identifier 166, persistence timeout information 168, and a destination identifier 170. The request identifier 166 may identify a request for a particular data element. For example, the request identifier 166 may be initialized based on the request identifier in the received response, as shown in FIG. 6B. The persistence timeout information 168 may include a timeout that, upon expiration, triggers the routing module 152 to remove the persistence information 164 entry and to close the connection (e.g., second connection) to a server identified by the destination identifier 170. For example, the destination identifier 170 may be utilized to identify another load balancer server 106 or an application server 108 to which a request was routed and from which a response was received.

FIG. 4B illustrates load balancer keep-alive information 172, according to an embodiment. The load balancer keep-alive information 172 may be stored on the load balancer server 106 and utilized by the load balancer server 106 to identify whether a connection (e.g., first connection) between the load balancer server 106 and a client machine 102 is kept alive. The load balancer keep-alive information 172 may include one or more entries of keep-alive information 174. Each keep-alive information 174 entry may include an incoming socket 176 and keep-alive timeout information 178. The incoming socket 176 may identify a connection between a client machine 102 and the load balancer server 106.

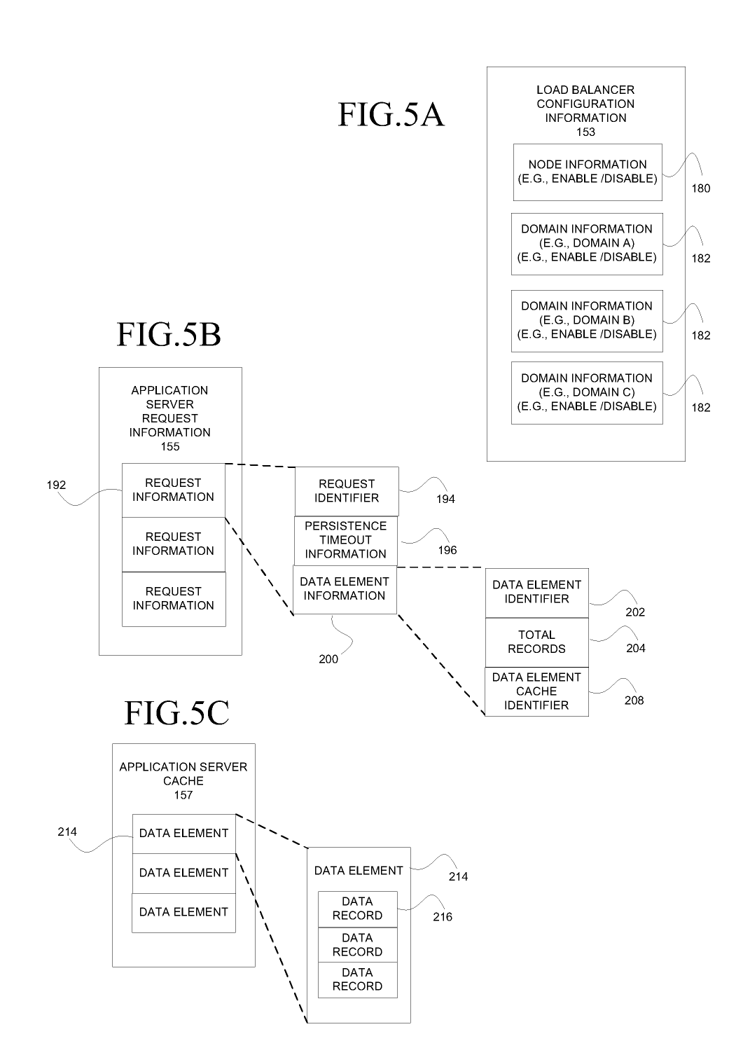

FIG. 5A illustrates load balancer configuration information 153, according to an embodiment. The load balancer configuration information 153 (e.g., keep-alive feature) may be stored on the load balancer server 106 and utilized by the load balancer server 106 to identify whether a connection (e.g., first connection) between the load balancer server 106 and a client machine 102 is kept alive. The load balancer configuration information 153 may include node information 180 and one or more entries of domain information 182. The node information 180 may indicate whether connections between the load balancer server 106 and any client machine 102 may be kept alive. For example, node information 180 that is registered as disabled effectively blocks keeping connections alive between the load balancer server 106 and all client machines 102. Each of the domain information 182 may indicate whether a connection between the load balancer server 106 and a client machine 102 servicing a request for a data element in the featured domain may be kept alive. For example, a request may include a uniform resource identifier that includes a request identifier, as shown in FIG. 6A that identifies a data element that is located in a domain A, and the domain information 182 for domain A may be disabled. Accordingly, the load balancer server 106 may be blocked from keeping alive a connection between the load balancer server 106 and the client machine 102 that originated the request for a data element in the domain A. The load balancer configuration information 153 may be overridden based on the above described keep-alive flag being asserted in a response. For example, load balancer configuration that is configured as disabled for a particular domain may be overridden by a keep-alive flag that is asserted in the response thereby causing the connection between the load balancer server 106 and the client machine 102 to be kept alive.

FIG. 5B illustrates application server request information 155, according to an embodiment. The application server request information 155 may be stored on the application server 108 and utilized by the application server 108 to manage a request that arrives on an incoming socket. The application server request information 155 may include multiple entries of request information 192.

The request information 192 may be stored by the application server 108 responsive to receiving a request 250, as shown in FIG. 6A, that is not already registered in the application server request information 155. Each request information 192 entry may include a request identifier 194, persistence timeout information 196 and data element information 200. The request identifier 194 may be initialized based on the request identifier that is included in the uniform resource identifier that's received as part of an incoming request, as shown in FIG. 6A. The request identifier 194 may be utilized to identify the data element that is being requested. The data element information 200 may be utilized to store a data element identifier 202, total data records 204, and a data element cache identifier 208. The data element identifier 202 may identify a location of the data element in persistent storage. For example, the data element identifier 202 may include a uniform resource identifier that identifies a location on the network of the data element. The total data records 204 may indicate the total number of data records in the data element. The data element cache identifier 208 may identify the location of the beginning of the data element in the cache.

FIG. 5C illustrates an application server cache 157, according to an embodiment. The application server cache 157 may be located on the application server 108 and utilized by the application server 108 to store and retrieve data elements 214. For example, the application server 108 may retrieve a data element 214 from persistent data storage 110 and store the data element 214 in the application server cache 157. The data element 214 may include one or more data records 216, according to an embodiment. Other embodiments may utilize other portions or units of data (e.g., a predetermined number of bytes, data item, segment, page, block, listing, any identifiable row in a table, etc.) that are selectable by a user or machine.

FIG. 6A illustrates a request 250, according to an embodiment. The request 250 may, for example, include a hypertext transport protocol (HTTP) request. The request 250 may include a header 251 and a body 268. The header may includes a method 252 (e.g. GET), a uniform resource identifier 253, and header information 254. The method 252 may identify an operation to be performed, including a “GET” operation that requests a resource such as the data element 214 or a portion of the data element 214, as previously described. The uniform resource identifier 253 may include a request identifier and a records identifier that identifies the particular data records 216 that are being requested. For example, the records identifier may indicate the first twenty data records from a set of three-thousand data records 216 that collectively comprise a data element 214. In some embodiments the uniform resource identifier 253 may not include the full path to the data element. In some embodiments the request identifier may be part or all of the uniform resource identifier 253.

FIG. 6B illustrates a response 270, according to an embodiment. The response 270 may include an HTTP response. The response 270 may include a header 272 and a body 274. The header may include header information 278, a remember-me flag 280, persistence timeout information 282, a request identifier, a keep-alive flag 283, keep-alive timeout information 284 and a cookie 285. The remember-me flag 280 may be asserted to signal the server that receives the response 270 to remember (e.g., persist) the server that was utilized to process the corresponding request 250. For example, the remember-me flag 280 may be asserted by an application server 108 to signal a load balancer server 106 to route subsequent requests 250 with the same request identifier in the uniform resource identifier 253 to the same application server 108 or load balancer server 106. The persistence timeout information 282 may include a suggested time period for which the load balancer server 106 performs the routing detailed above. The keep-alive flag 283 may be asserted to signal the web load balancer tier load balancer server 106 that receives the response 270 to keep the connection to the client machine 102 alive after communicating the response 270 to the client machine 102. The keep-alive timeout information 284 may include a suggested timeout period to be associated with the connection between the client machine 102 and load balancer server 106. The body 274 may include the data records 216 that were requested.

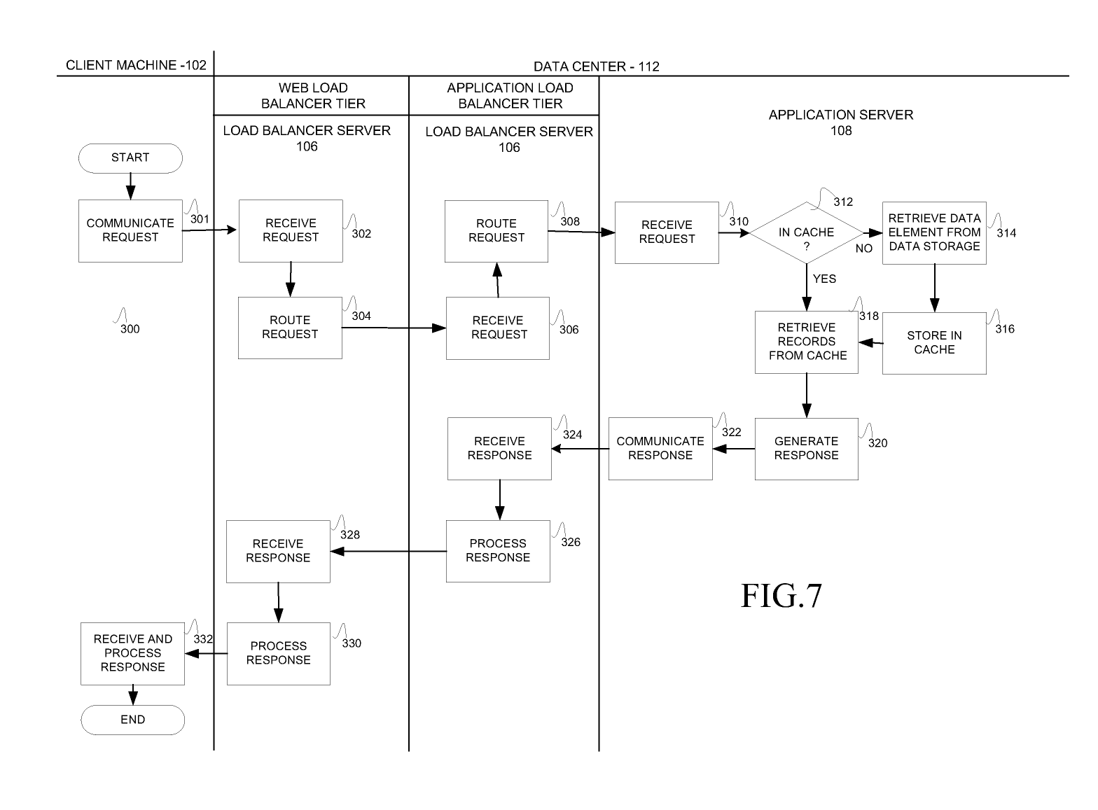

FIG. 7 illustrates a flow chart of a method 300 to control connections, according to an embodiment. Illustrated on the left is a client machine 102 and illustrated on the right is a data center 112. The data center 112 is shown to include a web load balancer tier on the left that includes a load balancer server 106, an application load balancer tier in the middle that includes a load balancer server 106, and an application server 108 on the right. It will be appreciated by one having skill in the art that the web load balancer tier and application load balancer tier may respectively include multiple load balancer servers 106. It will further be appreciated that multiple application servers 108 may be included, where each application server 108 or groups of application servers 108 are dedicated to servicing a particular domain. The method 300 may commence at the client machine 102, at operation 301, with a browser responding to a user selection by communicating a GET request 250 to get a set of data records in a data element 214. In the present example, the uniform resource identifier 253 in the request 250 may include a request identifier that identifies the data element 214 and a records identifier that identifies a range of data records to be retrieved. For example, the uniform resource identifier 253 may indicate record number 0 through record number 19 are to be retrieved.

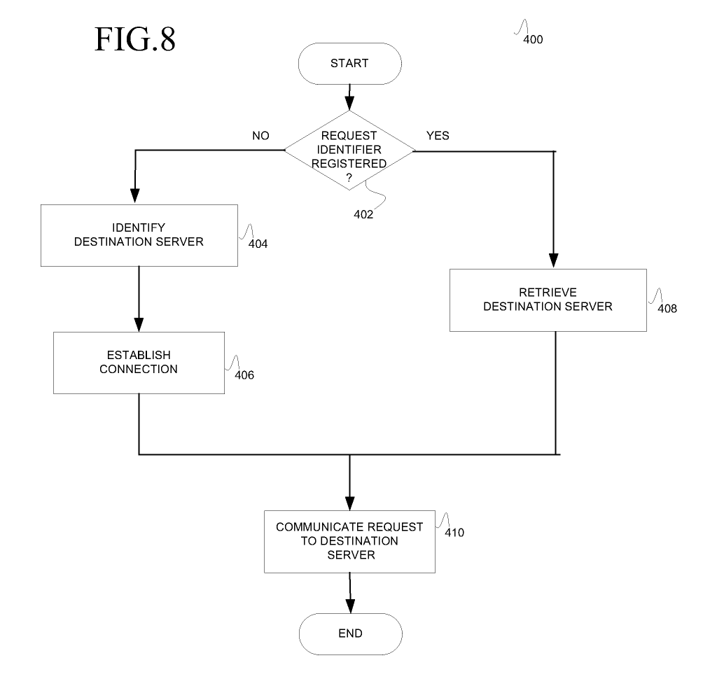

At operation 302, at the load balancer server 106 in the web load balancer tier, the communication module 150 may receive the request 250. At operation 304, the routing module 152 may route the request 250 to the appropriate destination, as further described in method 400 and illustrated on FIG. 8.

At operation 306, at the load balancer server 106 in the application load balancer tier, the communication module 150 may receive the request 250. At operation 308, the routing module 152 may route the request 250 to the appropriate destination, as further described in method 400 and illustrated on FIG. 8.

At operation 310, at the application server 108, the receiving module 154 may receive the request 250. The receiving module 154 may extract the request identifier from the uniform resource identifier 253 present in the request 250. At decision operation 312, the processing module 156 may identify whether the data element 214 associated with the request identifier is stored in the application server cache 157. For example, the processing module 156 may compare the request identifier extracted from the uniform resource identifier 253 with the request identifier 194 in each of the request information 192 entries in the application server request information 155 until a match is found or all of the request information 192 entries are exhausted. If a match is found, then a branch is made to operation 318. Otherwise a branch is made to operation 314.

At operation 314, the processing module 156 may retrieve the data element 214 from the data storage 110 based on the information present in the uniform resource identifier 253. For example, the uniform resource identifier 253 may include a request identifier that identifies a particular file that includes 3,000 data records that are persistently stored on the data storage 110. At operation 318, the processing module 156 may retrieve the appropriate data records from the application server cache 157 based on the request identifier 194 and the records identifier extracted from the uniform resource identifier 253 in the request 250. For example, the uniform resource identifier 253 may indicate that the data records numbered 10 through 50 are to be retrieved. At operation 316, the processing module 156 may store the data element 214 in the application server cache 157 and add a request information 192 entry to the application server request information 155. For example, the processing module 156 may copy the request identifier from the request 250 to the request identifier 194 in the request information 192 entry to identify the data element 214 stored in the application server cache 157. Further, the processing module 156 may initialize the persistence timeout information 196 by storing a timeout period that is proportional to the total number of data records 216 in the data element 214. Finally, the processing module 156 may initialize the data element information 200 in accordance with the data element 214 and the location in which the data element 214 is stored in the application server cache 157. At operation 320, the processing module 156 may generate the response 270. For example, the processing module 156 may store a cookie 285 and the data records 216 that were requested in the response 270. Further, the processing module 156 may set the remember-me flag 280 and the keep-alive flag 283 in the response 270 based on the uniform resource identifier 253 in the request 250. If the uniform resource identifier 253 does not identify the last record 216 in the data element 214, then the processing module 156 may assert the remember-me flag 280 in anticipation of receiving additional requests for data records 216 in the same data element 214. Further, the processing module 156 may update the persistence timeout information 282 and the keep-alive timeout information 284 in the response 270. Further, the processing module 156 may remove the request information 192 entry from the application server request information 155 responsive to identifying the uniform resource identifier 253 in the request 250 as requesting the last record 216 in the data element 214. At operation 322, the processing module 156 may communicate the response 270 over the connection to the load balancer server 106 in the application load balancer tier.

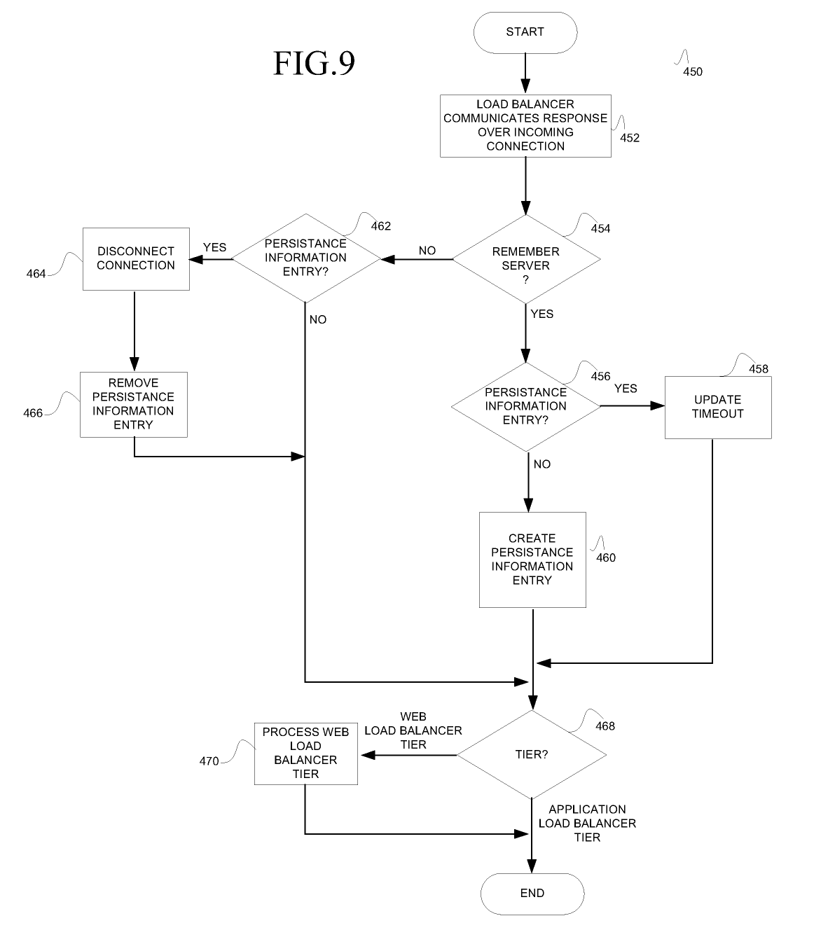

At operation 324, at the load balancer server 106 in the application load balancer tier, the communication module 150 may receive the response 270. At operation 326, the routing module 152 may process the response 270, as further described in method 450 and illustrated on FIG. 9. At operation 328, at the load balancer server 106 in the web load balancer tier, the communication module 150 receives the response 270. At operation 330, the routing module 152 may process the response 270, as further described in method 450 and illustrated on FIG. 9. At operation 332, at the client machine 102, the browser may receive and processes the response 270. In some instances, the browser may communicate subsequent requests 250 to retrieve additional data records 216 from the same data element 214. For example, the browser may receive a first selection that, in turn, causes the communication of a first request to retrieve data records 216 numbers 0 through 19 from a data element 214 consisting of three thousand data records, a second selection to retrieve data records 20 through 39, and so forth, until the last data record is selected.

FIG. 8 illustrates a flow chart of a method 400 to route a request 250, according to an embodiment. The method 400 may be executed by a load balancer server 106 in the web load balancer tier or the application load balancer tier. At decision operation 402, the routing module 152 may extract the request identifier from the uniform resource identifier 253 present in the request 250 to identify whether it is already registered in the load balancer persistence information 151. For example, the routing module 152 may compare the request identifier extracted from the uniform resource identifier 253 with each of the request identifiers 166 until a match is found or all of the persistence information 164 entries are exhausted. If a match is not found, then a branch is made to operation 404. Otherwise a branch is made to operation 408. At operation 404, the routing module 152 may identify the destination server based on the information in the request 250. For example, the routing module 152 may identify a domain in the request 250, lookup a downstream load balancer server 106 (e.g., destination server) to handle the request, or an application server 108 (e.g., destination server) to handle the request. At operation 406, the routing module 152 may establish a connection between the load balancer server 106 and the identified destination. At operation 408, the load balancer server 106 may retrieve the destination server from the destination identifier 170 in the appropriate persistence information 164 in the load balancer persistence information 151. At operation 410, the routing module 152 may communicate the request 250 over the connection (e.g., second connection) established with the destination server.

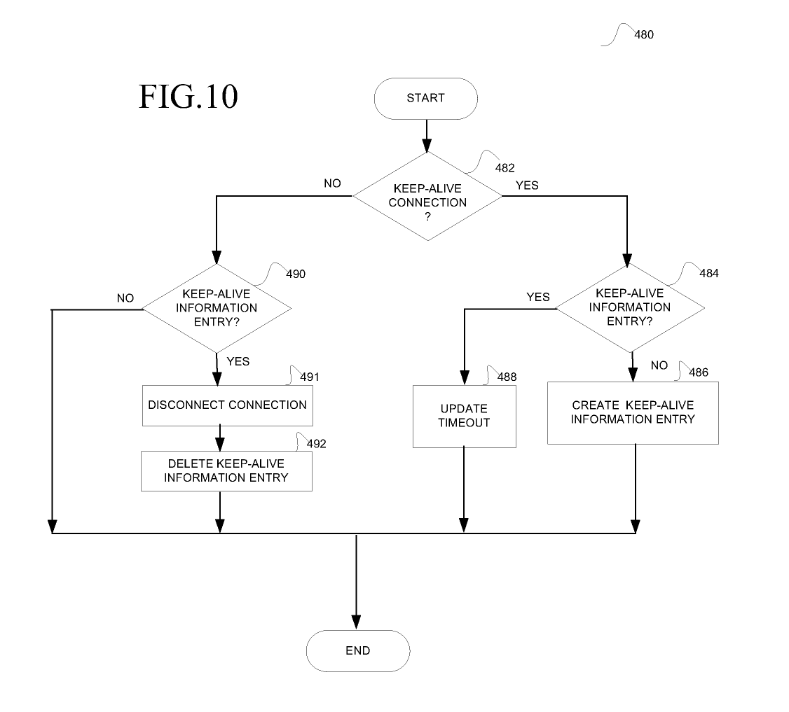

FIG. 9 illustrates a flow chart of a method 450 to process a response 270, according to an embodiment. The method 450 may be executed by a load balancer server 106 in the web load balancer tier or the application load balancer tier. At operation 452, at the load balancer server 106, the routing module 152 may communicate the response 270 over a connection. The connection is the same connection over which the corresponding request 250 was received. The request may have been received over a connection from a client machine 102 (e.g., first connection) or from a load balancer server 106 (e.g., second connection). At decision operation 454, the routing module 152 may identify whether to remember the server that communicated the response 270 based on the remember-me flag 280 in the response 270. If the remember-me flag is asserted in the response 270 then a branch is made to decision operation 456. Otherwise a branch is made to operation 462. At decision operation 462, the routing module 152 may identify whether the request identifier in the response 270 is associated with a persistence information 164 entry in the load balancer persistence information 151. For example, the routing module 152 may compare the request identifier in the header of the response 270 with each of the request identifiers 166 in the load balancer persistence information 151 until a match is found or all of the persistence information 164 entries are exhausted. If a match is not found, then a branch is made to decision operation 468. Otherwise a branch is made to operation 464. At operation 464, the routing module 152 may disconnect the connection (e.g., second connection) that was utilized to receive the response 270. At operation 466, the routing module 152 may remove the persistence information 164 entry that was previously identified in the load balancer persistence information 151 at decision operation 462. At decision operation 456, the routing module 152 may identify whether the request identifier in the response 270 is associated with a persistence information 164 entry in the load balancer persistence information 151, as previously described. If a match is found, then a branch is made to operation 458. Otherwise a branch is made to operation 460. At operation 460, the routing module 152 creates a persistence information 164 entry in the load balancer persistence information 151. For example, the routing module 152 may copy the request identifier from the response 270 into the request identifier 166 in the persistence information 164 entry, map the request identifier 166 to the application server 108 that serviced the corresponding request 250, store the identified application server 108 in the persistence information 164 entry as a destination identifier 170, and copy the persistence timeout information 282 from the response 270 to the persistence timeout information 160 in the persistence information 164 entry. Accordingly, the load balancer server 106 remembers the application server 108 that has stored the requested data element 214 in the application server cache 157 of the application server 108 to facilitate the efficient processing of subsequent requests 250 for additional data records 216. At operation 458, the routing module 152 updates the timeout in the persistence information entry 164 identified in decision operation 456. For example, the routing module 152 may store a timeout in the persistence timeout information 168 based on the persistence timeout information 282 in the response 270. At decision operation 468, the routing module 152 may identify whether the load balancer server 106 is positioned in the web load balancer tier or the application load balancer tier based on the tier information 162 in the load balancer persistence information 151. If the load balancer server 106 is positioned in the web load balancer tier then processing continues at operation 470, as described in method 480 on FIG. 10. Otherwise processing ends.

FIG. 10 illustrates a flow chart of a method 480 to process a web load balancer tier, according to an embodiment. The method commences at decision operation 482 with the routing module 152 identifying whether the keep-alive flag 283 is asserted in the response 270. If the keep-alive flag 283 is asserted then a branch is made to decision operation 484. Otherwise a branch is made to decision operation 490. At decision operation 484, the routing module 152 may identify whether the socket corresponding to the connection from client machine 102 is associated with a keep-alive information 174 entry in the load balancer keep-alive information 172. For example, the routing module 152 may compare the incoming socket utilized to communicate the response to the client machine 102 with each of the incoming sockets 176 in the load keep-alive information 172 until a match is found or all of the keep-alive information 174 entries are exhausted. If a match is not found, then a branch is made to operation 486. Otherwise processing continues at operation 488. At operation 488, the routing module 152 updates the keep-alive timeout information 178 associated with the keep-alive information 174 entry previously identified, with the keep-alive timeout information 284 in the response 270. At operation 486, the routing module 152 creates a keep-alive information 174 entry in the load balancer keep-alive information 172. For example, the routing module 152 may create the keep-alive information 174 entry based on the socket utilized to communicate the response to the client machine 102 and the keep-alive timeout information 284 in the response 270. At decision operation 490, the routing module 152 may identify whether the socket corresponding to the connection from client machine 102 is associated with a keep-alive information 174 entry in the load balancer keep-alive information 172, as previously described for decision operation 484. If a match is not found, then processing ends. Otherwise processing continues at operation 491. At operation 491, the routing module 152 may disconnect the connection between the load balancer server 106 and the client machine 102. At operation 492, the routing module 152 may remove the keep-alive information 174 entry identified in decision operation 490

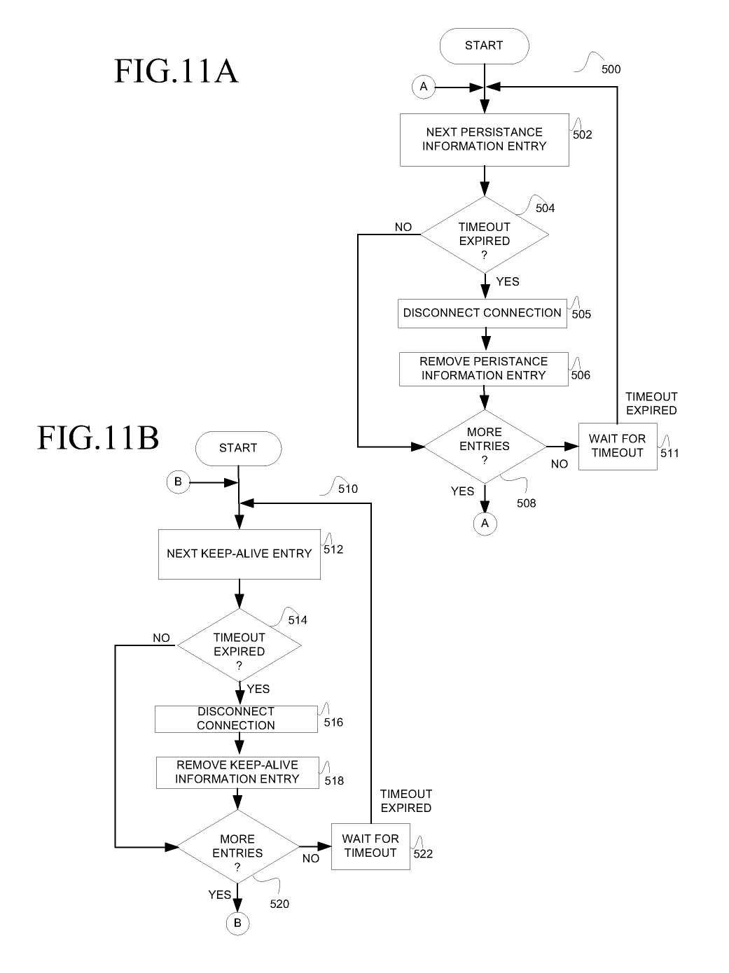

FIG. 11A illustrates a flow chart of a method 500 to service a timeout for a persisted connection, according to an embodiment. The method 500 may commence at operation 502 with the communication module 150 identifying the next persistence information 164 entry in the load balancer persistence information 151. At decision operation 504, the communication module 150 identifies whether the persistence timeout information 168 for a particular entry is expired. If the persistence timeout information 168 is expired a branch is made to operation 505. Otherwise a branch is made to decision operation 508. At operation 505, the communication module 150 may disconnect the connection (e.g., second connection) between the load balancer server 106 and the application server 108 if the connection was still retained by the load balancer server 106 or the communication module 150 may disconnect the connection (e.g., second connection) between the load balancer server 106 and another load balancer server 106 again assuming the connection was still retained by the load balancer server 106. At operation 506, the communication module 150 may remove the current persistence information 164 entry from the load balancer persistence information 151. At decision operation 508, the communication module 150 may identify whether there are more entries in the load balancer persistence information 151. If there are no more entries the communication module 150 then processing continues at operation 511. Otherwise processing continues at operation 502. At operation 511, the communication module 150 may set a timeout that upon expiration triggers the method 500 to begin again at operation 502.

The above method 500 describes the load balancer server 106 as removing persistence information 164 entries from the load balancer persistence information 151 based on persistence timeout information 168. A similar method may describe the application server 108 as removing request information 192 entries from the application server request information 155 based on persistence timeout information 196.

FIG. 11B illustrates a flow chart of a method 510 to service a timeout for a keep-alive connection, according to an embodiment. The method 510 may commence at operation 512 with the communication module 150 identifying the next keep-alive information 174 entry in the load balancer keep-alive information 172. At decision operation 514, the communication module 150 identifies whether the keep-alive timeout information 178 for a particular entry is expired. If the keep-alive timeout information 178 is expired a branch is made to operation 516. Otherwise processing continues at decision operation 520. At operation 516, the communication module 150 may disconnect the connection (e.g., first connection) utilized to communicate the response 270 to the client machine 102 and at operation 518 the communication module 150 may remove the keep-alive information 174 entry from the load balancer keep-alive information 172. At decision operation 520, the communication module 150 may identify whether there are more entries in the load balancer keep-alive information 172. If there are no more entries the communication module 150 then processing continues at operation 522. Otherwise processing continues at operation 512. At operation 522, the communication module 150 may set a timeout that upon expiration triggers the method 510 to begin again at operation 512.

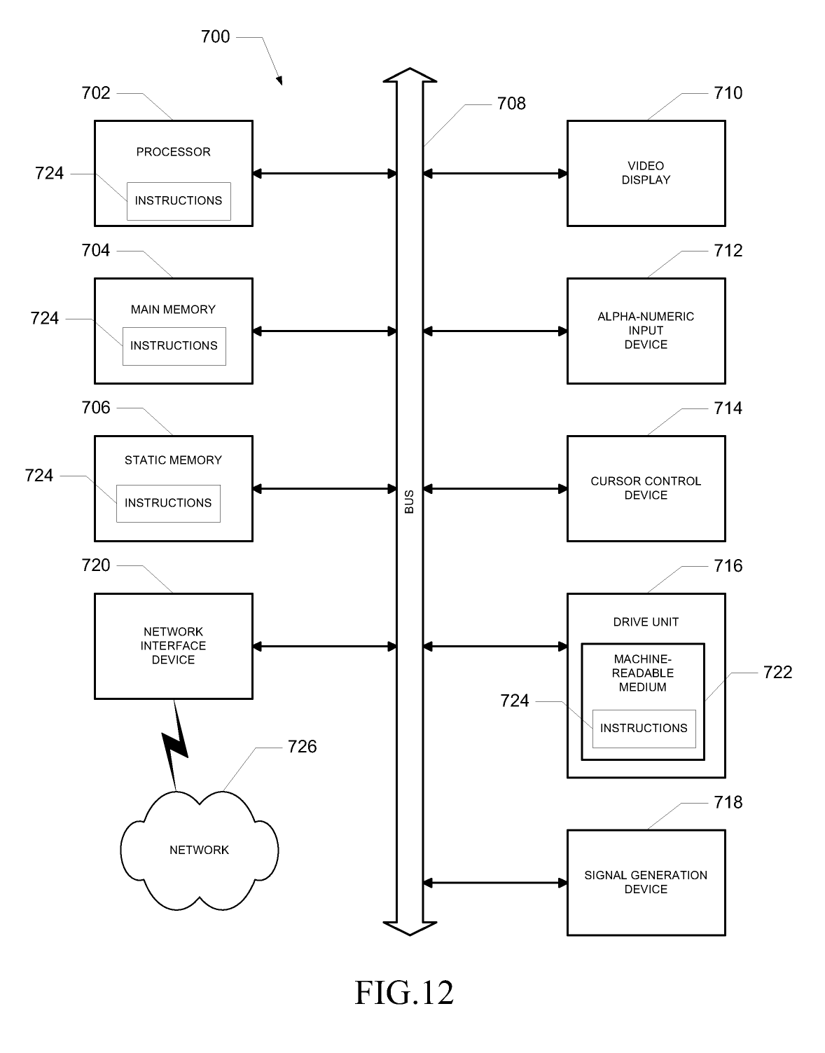

FIG. 12 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker), and a network interface device 720.

The disk drive unit 716 includes a machine-readable medium 722 on which is stored one or more sets of instructions 724 (e.g., software) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client, or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical and magnetic media, and carrier wave signals. As noted, the software may be transmitted over a network using a transmission medium. The term “transmission medium” shall be taken to include any medium that is capable of storing, encoding, or carrying instructions for transmission to, and execution by, the machine, and includes digital or analog communications signals or other intangible mediums to facilitate transmission and communication of such software.

The illustrations of embodiments described herein are intended to provide a general understanding of the structure of various embodiments, and they are not intended to serve as a complete description of all the elements and features of apparatuses and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized Accordingly, the specification and drawings are to be regarded in an illustrative rather than a restrictive sense.

Thus, systems and methods to efficiently retrieve a data element are disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

What is claimed is:

1. A method comprising:
receiving a first request over a first connection from a first network device, the first request being associated with a first domain and being received at a load balancer server, the first request further being for a first plurality of records that are included in a data element;
routing the first request to a first application server, the routing comprising:
identifying a first application server from a plurality of application servers based on the first domain, the first application server being utilized to service the first domain, the plurality of application servers respectively being utilized to service a plurality of different domains,
establishing a second connection to the first application server; and
communicating the first request over the second connection to the first application server to cause the first application server to retrieve the data element from data storage that persistently stores the data element;
receiving a first response from the first application server, the first response including an indication to persist the first connection by not disconnecting the first connection; and
communicating the first response over the first connection to the first network device and not disconnecting the first connection based on the indication to persist the first connection.

2. The method of claim 1, wherein the first response includes the first plurality of records.

3. The method of claim 1, further comprising setting a timeout associated with the first connection.

4. The method of claim 1, further comprising receiving a second request over the first connection from the first network device, the second request being for a second plurality of records that are included in the data element.

5. The method of claim 4, further comprising communicating a second response over the first connection to the first network device, the second response including the second plurality of records.

6. The method of claim 1, further comprising disconnecting the first connection responsive to identifying that a timeout is expired.

7. The method of claim 1, further comprising disconnecting the first connection based on a response that is subsequent to the first response and received from the first application server, the subsequent response including an indication to not persist the first connection to the first network device by disconnecting the first connection.

8. The method of claim 1, wherein the first network device is selected from a group of devices consisting of a second load balancer server and a client machine.

9. The method of claim 1, further comprising identifying configuration information that indicates keep-alive is disabled on the first connection and overriding the configuration information based on the indication in the first response to persist the first connection by not disconnecting the first connection.

10. A system comprising:
at least one processor;
a communication module that is executable by the at least one processor to receive a first request over a connection from a first network device, the first request being associated with a first domain and received at a load balancer server, the first request being for a first plurality of records that are included in a data element; and
a routing module to route the first request to a first application server, the routing module configured to:
identify a first application server from a plurality of application servers based on the first domain, the first application server being utilized to service the first domain, the plurality of application servers respectively utilized to service a plurality of different domains,
establish a second connection to the first application server; and
communicate the first request over the second connection to the first application server to cause the first application server to retrieve the data element from data storage that persistently stores the data element,
the communication module to receive a first response from the first application server, the first response includes an indication to not disconnect the first connection, the communication module to further communicate the first response over the first connection and not disconnect the first connection based on the indication to persist the first connection.

11. The system of claim 10, wherein the first response includes the first plurality of records.

12. The system of claim 10, wherein the routing module sets a timeout associated with the first connection.

13. The system of claim 10, wherein the communication module receives a second request over the first connection from the first network device, the second request being for a second plurality of records that are included in the data element.

14. The system of claim 13, wherein the communication module communicates a second response over the first connection to the first network device, the second response including the second plurality of records.

15. The system of claim 10, wherein the communication module disconnects the first connection responsive to an expiration of a timeout.

16. The system of claim 10, wherein the communication module disconnects the first connection based on a response that is subsequent to the first response and received from the first application server, wherein the response that is subsequent to the first response includes an indication to not persist the first connection.

17. The system of claim 10, wherein the first network device is selected from a group of devices consisting of a second load balancer server and a client machine.

18. The system of claim 10, wherein the routing module identifies configuration information that indicates keep-alive is disabled on the first connection and overrides the configuration information based on the indication in the first response to keep-alive the first connection by not disconnecting the first connection.

19. A non-transitory machine-readable medium storing instructions that, when executed by a machine, cause the machine to:
receive a first request over a first connection to a first network device, the first request associated with a first domain and being received at a load balancer server, the first request for a first plurality of records that are included in a data element;
route the first request to a first application server,
the machine to:
identify a first application server from a plurality of application servers based on the first domain, the first application server being utilized to service the first domain, the plurality of application servers respectively utilized to service a plurality of different domains,
establish a second connection to the first application server; and
communicate the first request over the second connection to the first application server to cause the first application server to retrieve the data element from data storage that persistently stores the data element;
receive a first response from the first application server, the first response including an indication to not disconnect the first connection; and
communicate the first response over the first connection and not disconnect the first connection.

20. A system comprising:
at least one processor;
a first means that is executable by the at least one processor to receive a first request over a first connection from a first network device, the first request being associated with a first domain and received at a load balancer server, the first request being for a first plurality of records that are included in a data element; and
a routing module to route the first request to a first application server, the routing module configured to:
identify a first application server from a plurality of application servers based on the first domain, the first application server being utilized to service the first domain, the plurality of application servers respectively being utilized to service a plurality of different domains,
establish a second connection to the first application server; and
communicate the first request over the second connection to the first application server to cause the first application server to retrieve the data element from data storage that persistently stores the data element,
the first means further for receiving a first response from the first application server, the first response including an indication to not disconnect the first connection, the first means further for communicating the first response over the first connection and not disconnecting the first connection based on the indication to persist the first connection.

21. A method comprising:
receiving a first request over a first connection from a first network device, the first request associated with a first domain, the first request being received at a load balancer server and further identifying a first plurality of records that are included in a data element;
routing the first request to a first application server, the routing comprising:
identifying a first application server from a plurality of application servers based on the first domain, the first application server being utilized to service the first domain, the plurality of application servers respectively being utilized to service a plurality of different domains,
establishing a second connection to the first application server; and
communicating the first request over the second connection to the first application server to cause the first application server to retrieve the data element from data storage that persistently stores the data element; and
receiving a first response from the first application server, the first response including a request identifier and an indication to remember the first application server in association with the request identifier.

22. The method of claim 21, further comprising:
storing a destination identifier that identifies the first application server and the request identifier as persistence information at the load balancer server.

23. The method of claim 22, further comprising:
receiving a second request over the first connection, the second request including the request identifier; and
identifying the request identifier in the second request matches the request identifier that is stored as persistence information at the load balancer server;
routing the second request to the first application server responsive to the identifying the match.

24. A system comprising:
at least one processor;
a communication module that is executable by the at least one processor to receive a first request over a connection from a first network device, the first request associated with a first domain, the first request is received at a load balancer server, the first request further identifies a first plurality of records that are included in a data element; and
a routing module to route the first request to a first application server, the routing module configured to:
identify a first application server from a plurality of application servers based on the first domain, the first application server being utilized to service the first domain, the plurality of application servers respectively utilized to service a plurality of different domains,
establish a second connection to the first application server; and
communicate the first request over the second connection to the first application server to cause the first application server to retrieve the data element from data storage that persistently stores the data element,
the communication module to receive a first response from the first application server, the first response includes a request identifier and an indication to remember the first application server in association with the request identifier.

25. The system of claim 24, wherein the routing module is configured to store a destination identifier that identifies the first application server and the request identifier as persistence information at the load balancer server.

26. The system of claim 25, wherein the communication module is configured to receive a second request over the first connection, the second request includes the request identifier, wherein the routing module identifies the request identifier in the second request matches the request identifier that is stored as persistence information at the load balancer server, and wherein the routing module routes the second request to the first application server responsive to the identification of the match.

27. A non-transitory machine-readable medium storing instructions that, when executed by a machine, cause the machine to:
receive a first request over a first connection to a first network device, the first request associated with a first domain and being received at a load balancer server, the first request to further identify a first plurality of records that are included in a data element;
route the first request to a first application server,
the machine to:
identify a first application server from a plurality of application servers based on the first domain, the first application server being utilized to service the first domain, the plurality of application servers respectively utilized to service a plurality of different domains,
establish a second connection to the first application server; and
communicate the first request over the second connection to the first application server to cause the first application server to retrieve the data element from data storage that persistently stores the data element;
receive a first response from the first application server, the first response including a request identifier and an indication to remember the first application server in association with the request identifier.
